(19) United States
(12) Patent Application Publication
(10) Pub. No.: US 2016/0164957 A1
(43) Pub. Date: Jun. 9, 2016

(54) Host Optimization For Network Accessible Software

(71) Applicants: Jaan Leemet, Austin, TX (US); Angela Saldana, Roswell, GA (US); Christopher J. DeBenedictis, Branford, CT (US); Paul Schmidt, Rocky Hill, CT (US); Albert R. Subbloie, JR., Orange, CT (US)

(72) Inventors: Jaan Leemet, Austin, TX (US); Angela Saldana, Roswell, GA (US); Christopher J. DeBenedictis, Branford, CT (US); Paul Schmidt, Rocky Hill, CT (US); Albert R. Subbloie, JR., Orange, CT (US)

(21) Appl. No.: 14/560,201

(22) Filed: Dec. 4, 2014

(51) Int. Cl. H04L 29/08; G06Q 30/04; H04L 29/06

(52) U.S. Cl. CPC H04L 67/1002; H04L 67/42; G06Q 30/04

(57) ABSTRACT

A system for determining optimal hosting providers and optimal providers for network accessible software applications including a system computer that communicates with a host server running the software application to determine actual usage or computing loads associated with the software application. The usage and/or computing loads are compared to billing models and performance data associated with different servers and/or different hosting providers to determine if options are available that could save money on the cost associated with the software application or provide different performance levels.

### FIELD OF THE INVENTION

The following invention relates to systems and methods for determining optimal hosting providers and providers for network accessible software applications based on usage of the hosted software programs and the computing power and optimal configuration required to execute the hosted software programs.

### BACKGROUND OF THE INVENTION

As internet speeds and computing power have progressively increased, hosted software programs have become more and more prevalent. Previously, when a software company wished to provide updates to a software program, there would be many users who would not upgrade and thus the software company would need to provide support for legacy versions. Further, not every user would have access to updated features absent purchase of an entirely new program. In addition, installation of the program would typically require a unique license code for each machine, making the installation and updating task a time consuming process.

Further, it may be necessary to run computationally intense operations on a computing device with appropriate hardware and computing power whereas a network accessible portion of the architecture may only require enough computing power to run the user interface.

In addition to internet speeds, encryption, reliability and security technologies have advanced. In connection with such advancement, many hosted servers are available to host anything from a simple website to a more complicated Software as a Service (Saas) platform. The software programs provided are accessible over a network connection and execute on a server which is remote to the user computer. The hosting provider is in some cases a third party who “rents” their servers. In some cases, this arrangement is referred to Infrastructure as a Service (IaaS) and in other cases a platform is used to develop the system referred to as Platform as a service (PaaS)

The market for hosting services and hosted applications is relatively new and is evolving rapidly. Often, hosting providers will have different charges and different ways to determine those charges for hosting a software program. For example, a simple website may pay a flat fee to allow a certain number of e-mail addresses and a certain amount of storage on the host server. If the website includes e-commerce tools such as credit card processing and encryption, charges may increase. As the hosted software program becomes more complicated and requires higher computing loads or additional services, the cost for hosting typically increases.

As one example, Amazon, INC. provides a service under the name AWS and one feature allows hosted software programs to be charged on a basis of use. Should the program have unusually high traffic, the computing power allocated to the hosted software program would elastically increase to meet demand, and when the traffic recedes, the computing power allocated would likewise decrease. Numerous other host providers offer similar services, however each host provider has a different charge or different way of charging for hosting the software program.

In addition, some SaaS programs charge for access based on usage. For example, remote backup and file sharing services such as Dropbox® have service levels based on the amount of storage used such that increased storage requires payment.

Companies and individuals with new and existing hosted software programs have difficulty selecting the appropriate host based on the actual or predicted computing power required. It is also difficult to determine the optimal hosted program or billing scenario to select as usage is difficult to determine, monitor or predict. Further, since each hosting provider may both have different charges and different ways to charge for computing power or usage, there is nearly no transparency to the process of selecting a host or service because few if any reliable cost comparisons can be used in making the decision on which host or service to select.

### SUMMARY OF THE INVENTION

It is therefore an object of the invention to provide a system for determining and comparing costs of hosting a software application between hosting providers and computing resources based on actual and/or historical usage.

It is another object of the invention to provide a system for determining and comparing costs of hosting a software application between hosting providers and computing resources based on predicted usage.

It is still another object of the invention to provide a system for determining an optimal provider hosted software application provider based on actual, historical and/or predicted usage.

It is still another object of the invention to provide a system for determining when the software application on hosted servers will require a change in computing power due to usage changes.

It is still another object of the invention to provide a system for determining when or under what circumstances a software application should be hosted with a different hosting provider.

These and other objects are achieved by providing a system computer that communicates with a host server running the software application to determine actual usage or computing loads associated with the software application. The usage and/or computing loads are then compared to billing models and performance data associated with different servers and/or different hosting providers to determine if other hosting options are available that could save money on the cost associated with the software application or provide different performance levels.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The term “performance” as used herein means capacity or ability of a computer, server, network, computer network or other computing device or combination of computing devices or resources to process and/or transmit data and/or the time and/or resources used to process or transmit data. There are a number of ways to measure “performance” and some examples include: response time, availability, processing speed, channel capacity, latency, bandwidth, throughput, relative efficiency, scalability, power consumption, compression ratio, RAM and combinations thereof, just to name a few examples.

In one aspect a system is provided for determining an optimal hosting provider for a network accessible software application. The system may include a first server associated with a first hosting provider and a software application executing on the first server and accessible via a network by a user device. A sensor module may be in communication with the first server for determining at least one metric indicative of a computing load on the first server wherein the computing load is indicative of a load placed upon the first server due to the software application executing on the first server. A storage may contain a data record indicative of a billing model for a second hosting provider and a system computer may be in communication with the sensor module and the storage and further have software executing thereon, the software comparing the at least one metric to the data records to determine a cost associated with hosting the software application on a second server. The software may generate a report indicative of the cost.

The second server may be associated with a second hosting provider. The first and second servers may each be associated with the first hosting provider. The first and second servers may each have a performance associated therewith. The performance associated with the first server may be higher than the performance associated with the second server. A second data record may be indicative of a billing model for the first hosting provider and the report may be further indicative of a second cost associated with the first hosting provider. The software may determine a performance requirement based on the at least one metric. The software may compare the performance requirement to the performance of the first and second servers to determine which of the first or second servers has a performance closest to the performance requirement to select one of the first or second servers. The report may be indicative of the selected one of the first or second servers. The performance of the selected one of the first or second servers may be at least equal to or greater than the performance requirement. The sensor module may include first and second sensor modules, the first sensor module executing on the system computer and the second sensor module executing on the first server. The second sensor module may be in communication with the first sensor module.

In other aspects a system is provided for predicting an optimal hosting provider for a network based software application. The system may include a first server associated with a first hosting provider and a software application executing on the first server and accessible via a network by a user device. A sensor module may be in communication with the first server for determining at least one metric indicative of a computing load on the first server wherein the computing load is indicative of a load placed upon the first server due to the software application executing on the first server. A prediction module may be generate at least one predicted metric based on the at least one metric and an extrapolated usage of the software application relative to usage associated with the at least one metric, wherein the at least one predicted metric is indicative of a predicted computing load placed upon at least one server as a result of the software application executing on the at least one server. A storage may contain a data record indicative a billing model for at least one hosting provider. A system computer may be in communication with the prediction module and the storage and further having software executing thereon, the software comparing the at least one predicted metric to the data record to determine a predicted cost associated with the at least one hosting provider for hosting the software application on the at least one server which is associated with the at least one hosting provider. The software may generate a report indicative of the predicted cost.

A predicted performance requirement may be associated with the software application and generated by the software based on the at least one predicted metric, the predicted performance requirement may be indicative of a minimum performance requirement for hosting the software application. The software may determine one or more acceptable servers wherein the one or more acceptable servers are selected from the at least one server and have a performance equal to or greater than the predicted performance requirement. The report may be indicative of the one or more acceptable servers wherein a predicted cost is associated with the one or more acceptable servers. The performance may be selected from the group consisting of: a response time, an availability, a processing speed, a channel capacity, a latency, a bandwidth, a throughput, a relative efficiency, a scalability, a power consumption, a compression ratio and combinations thereof. The at least one server may be the first server. The at least one server may be a server other than the first server. The at least one server may be associated with a second hosting provider different from the first hosting provider. The performance of the selected one of the first or second servers may be at least equal to or greater than the performance requirement.

In other aspects a system is provided for determining an optimal provider for a network accessible software application and may include a server and a software application executing on the server and accessible via a network by a user device. A sensor module may be in communication with the server for determining at least one metric indicative of a usage of the software application wherein the usage corresponds to the user device. A storage may contain a plurality data records, one of the plurality of data records indicative of a first billing model associated with the software application, another one of the plurality of data records indicative of a second billing model associated with a second software application. A system computer may be in communication with the sensor module and the storage and further having software executing thereon, the software comparing the at least one metric to the data records to determine a first cost due to usage of the software application and a second cost indicative of a predicted cost associated with usage of the second software application. The software may generate a report indicative of the first and second costs.

The at least one metric may be selected from the group consisting of: amount of usage in time, amount of usage in data size, number of files viewed, number of files downloaded and combinations thereof. A prediction module may generate a predicted metric based on the at least one metric and a change in usage relative to the usage. The software may compare the predicted metric to the first and second billing models to generate a first predicted cost associated with the first software application and a second predicted cost associated with the second software application. The change in usage may be an increase in usage. The change in usage may be a decrease in usage.

In other aspects a system is provided for determining an optimal hosting provider for a network accessible software application, the system may include a first server associated with a first hosting provider, the first server having a performance. A software application may execute on the first server and accessible via a network by a user device. A sensor module may be in communication with the first server for determining at least one metric indicative of a computing load on the first server wherein the computing load is indicative of a load placed upon the first server due to the software application executing on the first server. A prediction module may generate at least one predicted metric based on the at least one metric and a change in usage relative to the usage. A system computer may be in communication with the sensor module and the storage and further having software executing thereon, the software comparing the at least one predicted metric to the performance to determine a threshold indicative of a first usage having a predicted computing load greater than the performance. The software may generate a report indicative of the threshold. The report may be indicative of a second server. Said software application executing on the first and second servers results in a second performance greater than the performance and greater than the predicted computing load. The report may be further indicative of a cost associated with the second server. The software application executing on the second server results in a second performance greater than the performance and greater than the predicted computing load. The report may be indicative of a cost associated with the second server.

The threshold may relate to the number of concurrent users or growth in concurrent users. It is contemplated that a particular arrangement of servers, databases and/or other computing resources may hit its performance limit when the number of concurrent users reaches 100,000. In another example, the performance limit may not be reached, but a different hosting provider may be more expensive when hosting applications with a number of concurrent users larger than 100,000. The number of users however may change depending on the computing load due to the software application. For example, a simple software application may have a threshold of 100,000 users whereas a more complicated software application may have a threshold of 10,000 users. The prediction module may be used to determine these thresholds. The prediction module may also determine the threshold based on user growth such that if user growth is rapidly increasing, a prediction can be made as to when the number of concurrent users is enough to be more efficient or require a different hosting provider or additional computing power, the system can issue alerts, predictions and/or reports based on user growth. It is understood that growth in the number of concurrent users may indicate that it is more efficient to switch to a different billing model, different servers, and/or a different hosting provider.

Other objects of the invention and its particular features and advantages will become more apparent from consideration of the following drawings, claims and accompanying detailed description. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions or combinations of functions described herein.

### BRIEF DESCRIPTION OF THE DRAWINGS

FIG. 1 is a block diagram of one embodiment of the invention

FIG. 2 is functional flow diagram according to the block diagram of FIG. 1.

FIG. 3 is a functional flow diagram according to the block diagram of FIGS. 1 and 2.

FIG. 4 is a diagram showing an embodiment of how the report of FIG. 1 is generated.

FIG. 5 is a diagram showing an alternate embodiment of how the report of FIG. 1 is generated.

### DETAILED DESCRIPTION OF THE INVENTION

Referring now to the drawings, wherein like reference numerals designate corresponding structure throughout the views, the following examples are presented to further illustrate and explain the present invention and should not be taken as limiting in any regard.

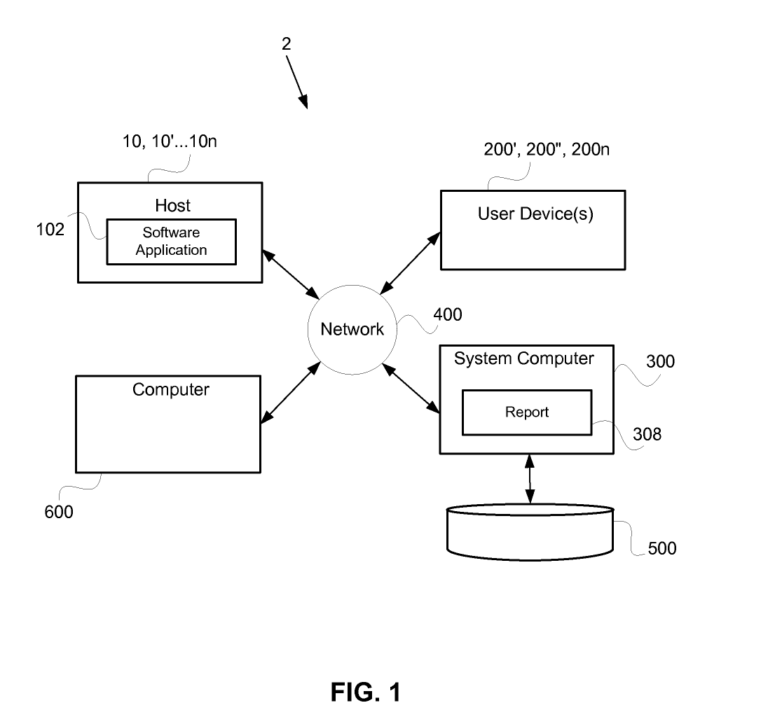

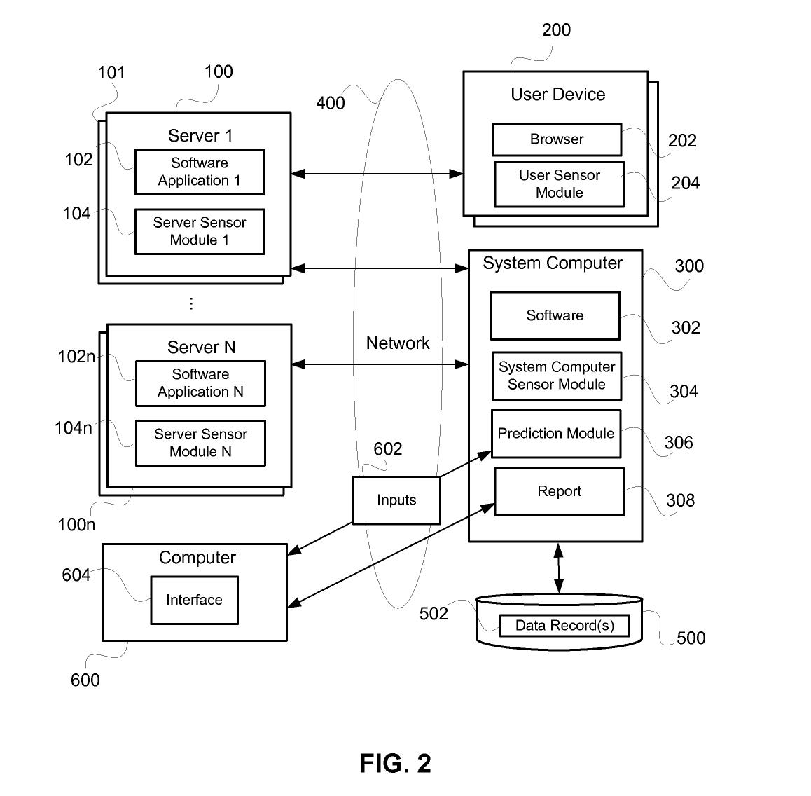

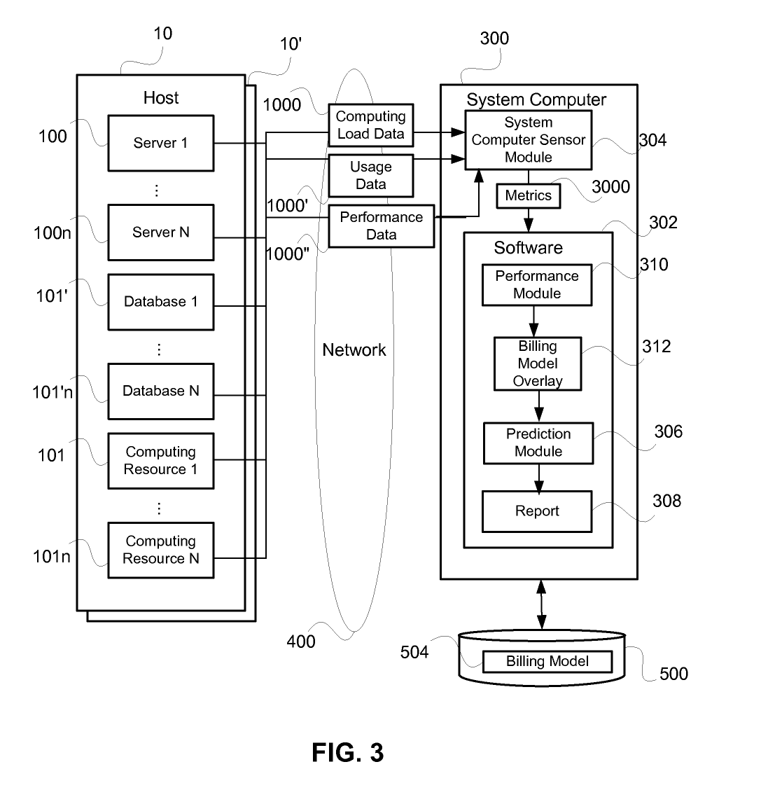

In FIG. 1, the system 2 is shown with host providers 10, 10′ . . . 10n having a software application 102 executing on their servers or other computing resources (see FIGS. 2 and 3 generally). Host providers are connected to a network 400. User devices 200′, 200″ . . . 200n, a computer 600 and a system computer 300 are also connected to the network 400, allowing one or multiple of the computers/servers/devices shown to communicate and exchange data.

Individuals and enterprises often develop software applications that are hosted on a server owned or controlled by a hosting provider. Some of these software applications may be accessed using a browser, and some may be accessed via a dedicated application or software program. Because each application has different computing requirements, hosting providers charge based on the computing loads due to the software application executing on the hosting provider servers. In some cases, the computing power allocated to the software application can dynamically adapt to usage of the software application and in other cases, the owner of the software application may contract for particular computing requirements as needed. The software application itself may also be provided to its users on a usage based billing model where metrics such as hours, data transfer and others are used to determine the cost of access to the software application.

In FIG. 2 first server 100 is shown having the software application 102 executing thereon. The server 100 shown may be associated with other computing resources 101 or databases 101′ as shown in FIG. 3. The software application 102 is accessed from the user device 200 over the network 400. In some cases, a browser 202 may be used to access the software application 102. Native application(s) on the user device 200 may also access the software application 102 in the place or in addition to the browser 202. The first server 100 may make up multiple servers or computing resources which are associated with a hosting provider 10. The system computer may be configured to monitor multiple applications hosted with the same hosting provider or hosted with different hosting providers such as on Server N 100n. Although not specifically shown in FIG. 2, it is understood that software application 102n can be in communication with and accessed by user device 200 via the network 400.

A number of sensor modules are shown in FIG. 1. A server sensor module 104 executes on the first server 100 and monitors the computing load on the first server 100 due to the software application 102 executing thereon. The user sensor module 204 executes on the user device 200 and the system computer sensor module 304 executes on the system computer 300, both of these sensor modules can monitor the computing load on the server either by communication with the server sensor module 104 or by communication with the software application 102. The computing load occurs due to execution of the software application 102 on the first server 100.

The software application may transmit data to the system computer 300 where the data is indicative of the computing load as measured by the software application. In other cases, an API or other interface may allow the system computer sensor module 304 to communicate with the user sensor module 204 and/or server sensor module 104 in order to capture the metrics needed to perform the analysis described herein.

One or more of the sensor modules 104/204/304 measure computing loads due to executing the software application 102 on the first server 100. The computing loads relate to different metrics that are used when the host provider bills the individual or company that hosts the software application 102 on the first server 100.

There are many different types of metrics available that relate to computing loads on the server(s). For example, RAM utilization, Disk utilization, and CPU utilization are commonly associated with computing loads. Further examples include: hours of server time, data transferred upstream, data transferred downstream, data processed (internal), IOPS (input output operations per second), database utilization such as database requests, database reads, database writes, database queries, concurrent open sessions, and maximum concurrent open sessions can be all be considered examples of computing loads. Numerous other metrics can be associated with computing loads. Additional examples include IP addresses assigned to or used by the software application, number of re-routs of the IP address to different computing resources/servers, performance or type of server, distribution of traffic per country/location, the number of SSL certificates, in-memory cache, number and size of email messages and attachments, video hosting, coding and streaming metrics, and others.

It is understood that these examples are not exhaustive and one of skill in the art would understand additional examples of metrics that can be associated with the computing load where the computing load is indicative of a load placed upon the server(s) due to the software application executing on the server(s).

The metrics may relate to usage of different computing resources of the server(s). These resources may have different performance levels and the system can track the computing load on each of the different resources. For example, regularly accessed data may be stored in a different place than data that is infrequently accessed. The regularly accessed data would then be associated with a higher computing power (higher performance) that would result in higher costs. The metrics would allow the system to differentiate between different computing resources that have different performance levels and different costs for computing loads.

The metrics can also be used determine computing loads in comparison to actual usage or what features of the software application are used by the user devices. Some examples of how data usage analysis is performed are described U.S. patent application Ser. Nos. 14/263,756, 14/263,772 and 14/550,434, the content of which is incorporated by reference herein. These applications involve a system that generates data transactions and in some embodiments the data transactions allow data usage over network connections to be quantified, allocated and understood in greater detail. The system may use these data transactions to designate usage and then may compare the usage to the metrics to determine how the usage impacts computing loads and thus the cost of hosting the software application.

In the example above where different performance levels or speeds are associated with different computing resources from the hosting provider, it may be more efficient from a cost perspective to store some data on a slower server when that data is only accessed on a limited basis. As a further example, it is contemplated that the software application may be configured initially to use a faster and more expensive database for storage and queries, but that based on the usage and the actual computing loads from the usage it would be more efficient to distribute some of the processing and database loads to a slower computing resource or one with less bandwidth. The system can therefore compare the metrics to the usage in order to find an optimal distribution of computing loads among different available computing resources.

One specific example databases with different performances is AWS or Amazon Web Services by Amazon, Inc. This system provides different databases with different performance levels. The “Amazon DynamoDB” is a high performance non-relational database service that provides predictable high performance and low latency at scale. This product may charge $250 or more per month for 1000 GB of storage. On the other hand “Amazon Glacier” is a low-cost storage that provides secure and durable storage for data archiving and backup. This product may be better suited where data retrieval over several hours is suitable performance. Storing 1000 GB on an Amazon Glacier instance may only cost $10 per month. Accordingly, data that is infrequently accessed and does not need to be retrieved quickly should be stored on lower cost storages when possible. Although the above example specifically describes Amazon products, it is understood that other host providers could have computing resources available with different performance levels and associated costs. Further, although the above example is specific to examples of database and storage usage, the example can also apply where different computing instances or servers have different performance levels which would be appropriate for some software applications and not others based on the metrics and associated computing loads. As an example, the owner or developer of the software application may designate or require certain performance requirements such as a response time less than two seconds. Based on the number of users and the performance of the servers etc, certain hosting providers may be able to meet the requirements and others may not. Still, some hosting providers may charge more for the performance whereas others may not. The performance requirements may be input through the interface 604 or may be included within the code or other data associated with the software application such that the system computer 300 may determine the performance requirement associated with the software application.

Usage and computing loads of the software application 102 may require a relatively high performance database for some functionality, but it is contemplated that the software application may not be initially programmed to distribute processing or storage between different databases of different performance levels and costs based on actual usage and metrics of computing load.

If a software application is initially programmed to use all high-performance database resources and the usage and metrics indicate that cost savings can be obtained by distributing some of the database usage to a lower performance and lower cost resource, the report can indicate this information to allow the software application owner to update the software application. Although a specific example of databases with different performance levels is discussed as an example, it is understood that similar examples may apply when discussing other performance characteristics of computing resources.

The software application 102 may have computing power requirements necessary to properly execute the software application on the selected server. The metrics allow the system computer to determine if the software application can be hosted with a less expensive alternative hosting provider. Although it is desirable in many cases to save costs, it would not be desirable to save costs with a substantial loss in performance of the software application due to inadequate performance levels of the server or hosting provider chosen. At the same time, some applications may be hosted on very high performance servers where the computing load from the application does not justify the expense of the high performance servers.

The performance of servers or computing resources associated with the hosting provider can be designated in the billing models. Example of performance characteristics include: RAM, Disk, response time, availability, processing speed, channel capacity, latency, bandwidth, throughput, relative efficiency, scalability, power consumption, and compression ratio, among others. The computing load associated with the software application may need to be equal or less than the performance of the server that is being compared to. For example, if a software application requires a bandwidth of 100 MB/sec to function properly, the system compare would generate the report based servers that can handle 100 MB/sec or higher because a 50 MB/sec server although likely less expensive would reduce the performance of the software application and potentially lead to crashing.

Availability may be measured with respect to reliability. As reliability increases, so may availability. For example, when a second redundant server, database and/or computing resource is on standby to switch over and take over the primary role on demand in the event that the primary server, database and/or computing resource fails. Availability may relate to outage time or tolerance. As an example, if a maximum downtime of three (3) minutes is set via the interface 604, there is likely to be a requirement of a redundant machine regardless of the number of users. There may be different costs for different availability levels. Availability may also refer to the excess capacity of a computer, network or computer system. For example, the excess bandwidth or RAM available via the server/network. Response time may refer to the total amount of time it takes to respond to a request for service or any unit of work. For example, a simple disk IO to loading a complex web page. Response time may be related to service time (how long it takes to do the work requested), wait time (how long the request has to wait for request queued ahead of it), and transmission time (how long it takes to move the request to the computer doing the work and back to the requestor). Processing speed in some cases refers operating frequency or speed per dollar. Channel capacity may refer to the tightest upper bound on the rate of information that can be transmitted over a communications channel. Channel capacity may also be a function of how reliability the information can be transmitted. Latency may refer to the time delay between the cause and the effect, as an example, the delay between what the user commands and when the computer provides the results. Bandwidth may refer to the bit-rate of available or consumed data communication resources, or may also refer to net bit rate, peak bit rate, information rate, physical layer useful bit rate, channel capacity, maximum throughput etc. In some cases, the maximum data rate of a physical communication link may be proportional to its bandwidth in hertz (ie frequency bandwidth etc.). Throughput may refer to the rate of production or the rate at which something can be processed. Scalability may refer to the ability of a system, network, computer or process to handle a growing amount of work. For example, the ability of the system to handle an increased computing load do to an increased number of users. Power consumption typically the amount of electricity used in wattage. Performance per watt may also be used to pick CPUs based on speed per watt of power. Data compression reduces resource usage and compression ratio is a measure of compression. Compressed data may require decompression for use and decompression may require additional processing power. The specific examples and explanations discussed in this paragraph are exemplary only and are not intended to be limiting.

The system can also use data transactions to compare to the metrics associated with computing loads to help determine how feature usage of the software application impacts computing loads so that appropriate hosted services and computing resources can be purchased or reserved to account for actual usage and the computing loads and that costs can be anticipated.

The report 308 is generated by the system computer to show alternative hosting providers or alternative servers within the control of the same hosting provider that would allow the owner of the software application to save money. The alternative hosting providers or servers may be required to meet performance levels that will be required by the software application based on the metrics or predicted metrics. The report 308 can be transmitted to or accessible by the computer 600. For example, the report may be sent via e-mail or may be accessible via a webpage.

The prediction module allows computing loads to be predicted based on increased or decreased usage, the predicted computing loads can be used to select appropriate hosting providers and/or particular servers or computing resources available from the hosting provider selected. As an example, a software application may include a beta test for 100 users and over a month, the interaction between the user devices 200 and the software application 102 may be monitored so that computing loads can be determined based on actual usage in the beta test. The prediction module allows the owner of the software application to expand the user base and then predict what the costs or computing performance requirements may be. The system may be configured to allow the owner to input 602 different user levels. The prediction module may receive input 602 from the computer via a user interface 604 such as a web-based interface or an application interface. Predicted metrics are calculated based on the input which may indicate increased usage to 200, 1000, 10,000 or more users depending on the input. It is also understood that the inputs 602 may include other information. For example, the system computer may also allow the owner to tag events associated with increased usage so that the system computer can determine the predicted impact on usage increase due to the event.

As an example of an event, a business may provide a web based service using the software application 102 and this service may be featured on a television show, on a popular website or there may be celebrity reviews or endorsements that drive traffic to the software application 102. Although the timing of these events may be difficult to predict, they can be tagged via the system so that the usage increase due to the event can be quantified and tracked. This would allow future events that carry similar usage increases to be accounted for and planned for such that when future events are predicted based on reviews or promotions that computing loads can be predicted as can costs. The prediction module may both allow the owner of the software application to determine predicted costs and further determine if the increased computing load can be handled by the server currently hosting the software application. If software 302 of the system computer determines that the current host provider either cannot host the application with increased usage due to inadequate performance or is too expensive, alternate hosting providers can be determined and a report 308 generated.

Tagging of increased usage events can also be used across multiple applications and owners. For example, a software application 102 may have increased usage due to an event where a television program features the software application 102 or business associated with the software application 102. There may be a percentage increase or user increase associated with the event, and when the event is tagged, the system can track the event and data relating to the event can be stored in the database 500. When the second application 102n or business is featured on the same or similar television program, it is possible to predict the increased usage and therefore the increased computing load on the server 100n. Therefore additional inputs 602 can be entered into the prediction module where there are events that are expected to occur in the future. This would allow the prediction module to receive information about the event and its expected date and then based on historical data about similar events that drive usage or traffic, predicted metrics can be generated and reports issued detailing costs and predicted computing loads. Therefore, tagging an event allows the system to associate increased usage with different categories or types of events, in the example of the television show, the tag associated with a television show can be associated with ratings that indicate the viewership, therefore, as there are events that use alternate television shows, usage may be predicted with respect to television ratings. This allows for more accurate predictions which may help the owner of the software application to plan for and react to the predicted computing loads and costs. In some cases, this will require that additional computing power offered by the hosting provider, for example server 101 is reserved or made accessible to the software application to avoid crashing or unavailability of the software application. The report 308 can indicate if additional computing power is required based on predicted usage. Although the example of a television show is discussed herein it is understood that this disclosure is not limited specifically to featuring the software application or business on a television show as other events may drive increases in usage of the software application.

If expansion is only needed for a special event, it may be desirable not to expand the system to a different tier of service or to a different host provider initially. The long term consequences of the event may not yet be known and although it may be more expensive to stay with the same host provider and reserve or purchase additional servers or performance, the internal cost or time used in switching host providers may not be worth saving money with the hosting provider.

In some cases, these events and the expansion could potentially be predicted based on historical data. For example, if the Superbowl is coming this Sunday and historical data shows a doubling in traffic, it may be desirable to reserve appropriate performance for such an event on a temporary basis. The event could also be learned behavior of the system. For example, growth in traffic and therefore computing power every last Sunday of a certain month, every payday, every end of month/quarter. The event could also be based on external input such as an owner of the software application inputting information into the interface 604 that tells the system what the increased usage will be. In response to this input, the system may determine the best hosting provider and/or billing model going forward.

Transitioning from one billing model to another or from one host provider to another and the cost associated with this should also be factored into the equation. For example, if it costs $1000 to switch from Amazon to Azure for one day to account for an event such as the Superbowl but there is a savings of $500 switching would not be worth the cost. It is understood that costs may be internal and/or external. Internal costs may be the time spent by the company's programmers to switch hosting providers. External costs may be the costs paid to the new or old hosting provider due to the switch.

The prediction module can also be used to determine when changes to hosting providers should be made as usage of the software application increases or decreases. For example, a software application initially hosted one server A could have 2000 users on a daily basis. This usage would be associated with a computing load on server A, but as the number of users increase, the computing load on server A may increase. The decision to switch to a different server may be based on server A not being able to handle 10,000 daily users based on computing load. Although in the example of 2000 users, server A is used, handling 10,000 users could be done with 5 servers of server A's capacity and performance. Alternately, an alternate server that can handle 10,000 users may be more or less expensive, depending on the hosting provider and the computing load of the software application. Based on the computing loads, thresholds can be determined such that the report includes an alert that either based on usage or the rate of usage growth or contraction. This alert can indicate that different servers or different hosting providers should be used.

The prediction module 306 can compare usage and the computing load metrics to scenarios of increased usage to generate predicted metrics which allows the software 302 to generate reports 308 based on predicted usage. The reports may be generated by comparing billing models associated with the data records 502 to the metrics or predicted metrics that are obtained based on one or more of the server, user or system computer sensor modules 104, 204, 304. In one example, the increased usage may be based on an increased number of users accessing the software application 102.

The billing models of hosting providers may be related to the computing load on the server or the number of servers allocated to the software application. For example, some bill based on what computing resources are reserved and some bill based on what is used. These computing resources such as the servers 102 . . . 102n and 101 may have varied performance and costs. The models become more complicated when different hosting providers bill based on different types of computing loads and the performance of the servers varies. When testing a particular program based on predicted metrics or simply based on actual usage, hardware and software statistics which may form the computing load can be monitored by the sensor module. Computing loads may be determined from the CPU usage, memory, disk IO, response time, and throughput among others from the server in response to execution of the software.

As an example, CPU usage may refer to the number of cores used. Each core may have an associated RAM and Disk size and these could vary amongst providers or may be independently configurable. For example, if 800 GB Disk size is required, some host providers will only associate a CPU core with 600 GB and 20 GB of RAM. The application may only need one CPU core from a RAM standpoint, but the Disk required may be larger than the one CPU core allows. This application would therefore require usage of two CPU cores just to meet the Disk utilization, but the application would be allocated more computing power than necessary, because the only reason in this example for using two CPUs is to have enough Disk space. A second hosting provider may provide a CPU core with 400 GB Disk and 10 GB RAM such that it is possible to reserve two CPU cores from the second hosting provider at a cost less than the first hosting provider. Maximum RAM or maximum expansion slots for RAM may also limit which servers are available or optimal given the requirements of the software application.

In some cases, the Disk space is independently configured and billed separately so that the CPU cores and RAM can be selected and then the disc size configured to match requirements. The sensor module allows the system to determine what is actually being used and then either overlay actual usage or predicted usage on different billing models including data relating to varied options as to how the servers, disks, databases etc can be configured in relation to cost.

Some operations may require different types of storage with different redundancies. As an example, there may be both “temporary” and “block” storage offered by the hosting provider. The block storage has multiple levels of redundancy for disaster recovery and may be more expensive than storage that less redundancy or is temporary. It is possible that the software application is configured to run all storage through redundant or block storage for security but that some of the data stored is accessed infrequently and only used for short periods of time. Usage data can be compared to the load associated with the infrequently accessed data to allow the developer to determine if block or redundant storage is really necessary. Switching operations to temporary storage could provide a cost savings over the more permanent block storage when the temporary data does not require the redundancy.

FIG. 3, the hosting provider 10 is shown having a number of servers 100 . . . 100n, databases 101′ . . . 101′n and other computing resources 101 . . . 101n associated therewith. The software application 102 executes on, uses or otherwise accesses the various servers, databases and computing resources. The different servers, databases and computing resources can each have different performances and costs based on usage or computing loads. It is also understood that in some cases, host providers will require that servers are reserved for certain applications so that at times of peak usage, adequate computing power is delivered. The host provider may charge based on reservation even if the associated resource is not actually used. The computing load data 1000 may indicate both actual computing load and reserved computing load. The system computer sensor module 304 can use the computing load data 1000, usage data 1000′ and/or performance data 1000″ to determine the metrics 3000 that are used by the software 302 to compare to the billing model.

The performance module 310 may determine what computing power is required by the software application in order to reliably execute and operate and metrics 3000 based on performance data. This may help the system determine if inadequate performance is being delivered. Based on the performance requirements, billing models 504 can be selected that meet the performance requirements and the software 302 can perform a billing model overlay 312 that determines the cost of hosting the software application on an alternate hosting provider 10′.

It is also understood that the billing model overlay can be performed on the existing hosting provider 10 to determine if the software application would be less expensive to run on server 100n than on server 100. The comparison can be run based on other databases, or computing resources whether associated with the existing hosting provider 10 or the alternate hosting provider 10′.

The prediction module may also be used to determine what threshold of users, usage or computing loads or growth thereof would make it more efficient to change to a different host based on performance requirements or cost savings. The report may be indicative of the different thresholds and hosting providers suggested based on how the software application runs or is expected to run under with a change in computing load or users.

The usage data 1000′ may also be used by the sensor module to generate metrics 3000 to compare different software applications. For example, some software applications and their providers have multiple different billing models for the same service and the most efficient billing model would depend on how the user actually interacts with the software application. Some applications are billed on an hourly basis, some based on amount of data used or transferred, some based on number of webpage impressions or requests. Further, the information accessed via the software application may be grouped into categories where different categories have different costs of access. Based on the actual usage of these applications, it is possible for the sensor module to generate metrics 3000 that are compared to the billing model 312. The performance module 310 in this example can compare alternate software applications that can substitute either in full or in part for the software application currently in use. If the information or capabilities of the alternate software application is sufficient to meet the needs based on the usage data 1000′, the report 308 may be generated to indicate where savings can be obtained, for example, with limited or no sacrifice to functionality and features.

Tracking the usage of the software application and comparing this usage to the computing load may also allow the system to provide further insight into how the software application functions. For example, it is possible that certain features of a software application could create higher computing loads or be associated with sharp spikes in computing loads. This can simply be a result of what the feature is. For example, video streaming will typically require more bandwidth than e-mail messages. It is also contemplated that the software application source code can be modified to reduce the computing load due to different modules or sections of the software application. Therefore, the usage data 1000′ and the computing load data 1000 can be compared to determine which features or parts of a software application code result in the what computing loads or parts thereof. This may provide the software application developer/owner with further insight into the efficiency of the software application and where possible improvements can be made to the software code that could result in the same functionality with a lower computing load. If the computing load is lowered, it may be expected that the software application more efficiently provides the same functionality with less likelihood of crashing. At the same time, a lower computing load can result in less cost for hosting the software application.

It is also contemplated that computing loads can indicate when virtual operations are preformed. If there are frequent virtual operations associated with the software application, the performance and computing loads associated with these may also be tracked by the system to determine if an alternate hosting provider can deliver better performance. In some cases, higher performance of virtual operations may result in higher charges, but a cost to performance ratio can be used to provide further clarity. The report may indicate this information based on actual performance and computing loads as well as predicted computing loads. The Billing model overlay 312 can be performed and the report 308 generated based on a ratio of cost to performance using performance data 1000″.

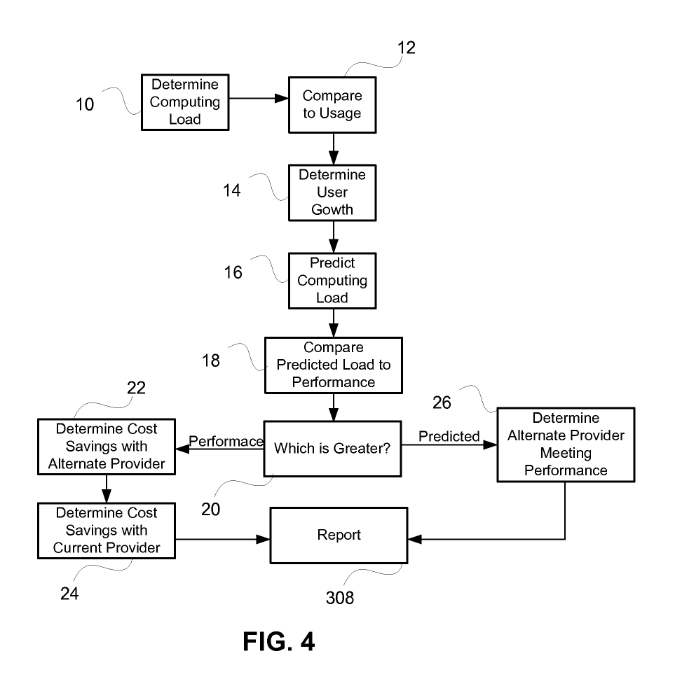

FIG. 4 shows an example of how computing load and usage can be compared by the system to determine alternate hosting providers and when switching to alternate hosting providers is necessary. The computing load is determined 50 and this computing load is compared to usage 12 to determine user growth 14. This allows the system to predict computing load 16 based on user growth 14. As an example, user growth may be relative to time and due to increased numbers of users or increased usage by the existing users and combinations thereof. The predicted computing load is compared to the performance 18 where the performance is associated with the servers. The performance 18 may be a maximum performance or delivered performance. If the performance is greater than required, it may be possible to reduce cost with an alternate provider 22 or it may be possible to use different servers, databases or resources and achieve savings with the current provider 24. The report 308 is generated based on this information.

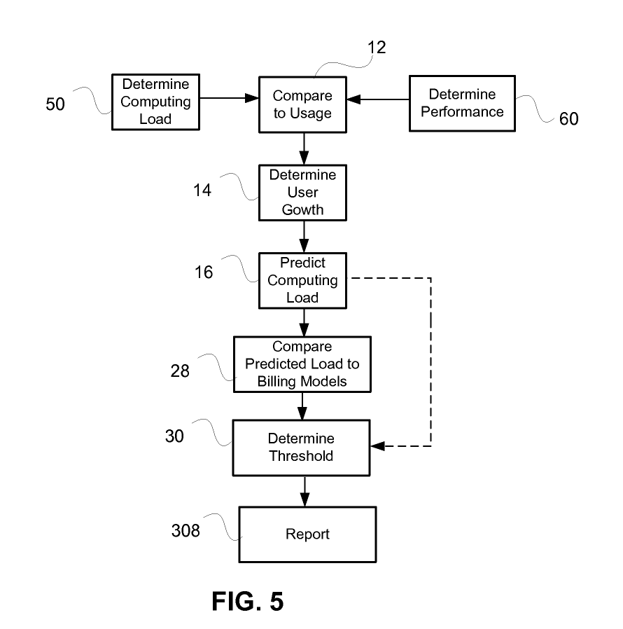

When the predicted load is higher than the performance of the server etc. alternate providers are determined 26 and the report 308 may be generated based on this information. In some cases, the report 308 may be an alert that is sent to the developer, IT manager or other person responsible for ensuring that the software program remains operational and does not crash. The alert may also suggest alternate hosting providers or additional resources of the existing provider that can be reserved to account for the performance increase. In FIG. 5, once the predicted computing load is determined 16, the predicted load can be compared to one or multiple billing models 28. It is understood that multiple predicted loads can be determined based on different scenarios of usage and changes in features and functions of the software application among others. Thresholds can be determined 30 based on predicted computing loads and these thresholds can indicate when or under what scenarios it is cost effective to change hosting providers. The change in hosting providers may be needed due to performance requirement changes, cost savings, combinations thereof and others.

In FIG. 5 an additional example is shown where thresholds are determined based on computing loads, usage, performance, user growth and/or billing models and combinations thereof. The computing load is determined 50 and this computing load may be compared to usage 12 to determine user growth 14. Performance may also be determined 60 and compared to usage 12 as well. This allows the system to predict computing load 16 based on user growth 14 and may also predict when performance of the servers hosting the software application is insufficient based on usage. In one example shown billing models 28 are used determine predicted costs and generation of thresholds 30. The thresholds are reported 308. The thresholds 30 may indicate when it is cost effective to switch to different server(s), add server(s) or change hosting providers.

The threshold may also be based on performance such that when the threshold indicates when additional servers, databases or other computing resources are needed or expected to be needed based on user growth. The report 308 can indicate from a cost standpoint and/or from a performance standpoint when hosting providers should be switched or when additional servers, databases or other computing resources are needed to run the software application.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for determining an optimal hosting provider for a network accessible software application comprising:
a first server associated with a first hosting provider;
a software application executing on said first server and accessible via a network by a user device;
a sensor module in communication with the first server for determining at least one metric indicative of a computing load on said first server wherein the computing load is indicative of a load placed upon said first server due to said software application executing on said first server;
a storage containing a data record indicative of a billing model for a second hosting provider;
a system computer in communication with the sensor module and the storage and further having software executing thereon, the software comparing the at least one metric to the data records to determine a cost associated with hosting said software application on a second server;
said software generating a report indicative of the cost.

2. The system of claim 1 wherein said second server is associated with a second hosting provider.

3. The system of claim 1 wherein said first and second servers are each associated with the first hosting provider.

4. The system of claim 1 wherein said first and second servers each have a performance associated therewith.

5. The system of claim 4 wherein the performance associated with the first server is higher than the performance associated with the second server.

6. The system of claim 1 further comprising a second data record indicative of a billing model for the first hosting provider wherein said report is further indicative of a second cost associated with the first hosting provider.

7. The system of claim 4 further comprising:
said software determining a performance requirement based on the at least one metric;
said software comparing the performance requirement to the performance of said first and second servers to determine which of the first or second servers has a performance closest to the performance requirement to select one of the first or second servers;
said report indicative of the selected one of the first or second servers.

8. The system of claim 6 wherein the performance of the selected one of the first or second servers is at least equal to or greater than the performance requirement.

9. The system of claim 1 wherein the sensor module comprises first and second sensor modules, the first sensor module executing on said system computer and the second sensor module executing on said first server, said sensor module in communication with the first sensor module.

10. A system for predicting an optimal hosting provider for a network based software application comprising:
a first server associated with a first hosting provider;
a software application executing on said first server and accessible via a network by a user device;
a sensor module in communication with the first server for determining at least one metric indicative of a computing load on said first server wherein the computing load is indicative of a load placed upon said first server due to said software application executing on said first server;
a prediction module for generating at least one predicted metric based on said at least one metric and an extrapolated usage of said software application relative to usage associated with the at least one metric, wherein said at least one predicted metric is indicative of a predicted computing load placed upon at least one server as a result of said software application executing on the at least one server;
a storage containing a data record indicative a billing model for at least one hosting provider;
a system computer in communication with the prediction module and the storage and further having software executing thereon, the software comparing the at least one predicted metric to the data record to determine a predicted cost associated with the at least one hosting provider for hosting said software application on the at least one server which is associated with the at least one hosting provider;
said software generating a report indicative of said predicted cost.

11. The system of claim 10 further comprising:
a predicted performance requirement associated with said software application and generated by said software based on said at least one predicted metric, said predicted performance requirement indicative of a minimum performance requirement for hosting said software application;
said software determining one or more acceptable servers wherein the one or more acceptable servers are selected from the at least one server and have a performance equal to or greater than said predicted performance requirement.
said report further indicative of the one or more acceptable servers wherein a predicted cost is associated with the one or more acceptable servers.

12. The system of claim 11 wherein the performance is selected from the group consisting of: a response time, an availability, a processing speed, a channel capacity, a latency, a bandwidth, a throughput, a relative efficiency, a scalability, a power consumption, a compression ratio and combinations thereof.

13. The system of claim 10 wherein the at least one server is the first server.

14. The system of claim 10 wherein the at least one server is a server other than the first server.

15. The system of claim 13 wherein the at least one server is associated with a second hosting provider different from the first hosting provider.

16. The system of claim 11 wherein the performance of the one or more acceptable servers is at least equal to or greater than the performance requirement.

17. A system for determining an optimal provider for a network accessible software application comprising:
a server;
a software application executing on said server and accessible via a network by a user device;
a sensor module in communication with the server for determining at least one metric indicative of a usage of the software application wherein the usage corresponds the user device;
a storage containing a plurality data records, one of the plurality of data records indicative of a first billing model associated with the software application, another one of the plurality of data records indicative of a second billing model associated with a second software application;
a system computer in communication with the sensor module and the storage and further having software executing thereon, the software comparing the at least one metric to the data records to determine a first cost due to usage of the software application and a second cost indicative of a predicted cost associated with usage of the second software application;
said software generating a report indicative of said first and second costs.

18. The system of claim 17 wherein the at least one metric is selected from the group consisting of: amount of usage in time, amount of usage in data size, number of files viewed, number of files downloaded and combinations thereof.

19. The system of claim 17 further comprising:
a prediction module for generating a predicted metric based on said at least one metric and a change in usage relative to the usage;
said software comparing the predicted metric to the first and second billing models to generate a first predicted cost associated with the first software application and a second predicted cost associated with the second software application.

20. The system of claim 19 wherein the change in usage is an increase in usage.

21. The system of claim 19 wherein the change in usage is a decrease in usage.

22. A system for determining an optimal hosting provider for a network accessible software application comprising:
a first server associated with a first hosting provider, said first server having a performance;
a software application executing on said first server and accessible via a network by a user device;
a sensor module in communication with the first server for determining at least one metric indicative of a computing load on said first server wherein the computing load is indicative of a load placed upon said first server due to said software application executing on said first server;
a prediction module for generating at least one predicted metric based on said at least one metric and a change in usage relative to the usage;
a system computer in communication with the sensor module and the storage and further having software executing thereon, the software comparing the at least one predicted metric to the performance to determine a threshold indicative of a first usage having a predicted computing load greater than the performance;
said software generating a report indicative of the threshold.

23. The system of claim 22 wherein said report is indicative of a second server.

24. The system of claim 23 wherein executing said software application on said first and second servers results in a second performance greater than the performance and greater than the predicted computing load.

25. The system of claim 24 wherein the report is further indicative of a cost associated with said second server.

26. The system of claim 23 wherein executing said software application on said second server results in a second performance greater than the performance and greater than the predicted computing load.

27. The system of claim 26 wherein the report is further indicative of a cost associated with said second server.
